(19) United States
(12) Patent Application Publication
(10) Pub. No.: US 2007/0153092 A1
(43) Pub. Date: Jul. 5, 2007

(54) VIDEO CAMERA APPARATUS FOR WHOLE SPACE MONITOR

(76) Inventors: Chin-Tien Yang, Hsinchu City (TW); Yu-Sheng Cheng, Taipei County (TW); Yu-Min Chen, Taipei County (TW); Cheng-Hung Weng, Taipei County (TW); Hung-Jen Chen, Taipei County (TW); Ruei-Shiang Lin, Taipei County (TW); Hui-Shan Chen, Taichung County (TW); Yi-Shiuan Hsu, Taoyuan County (TW); Sheng-Chia Lee, Taipei County (TW); I-Hao Chan, Taichung County (TW); Yi-Jen Cheng, Taipei County (TW); Chi-Ming Lin, Taoyuan County (TW); Chan-Sheng Lin, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/306,635

(22) Filed: Jan. 5, 2006

(51) Int. Cl. H04N 5/225

(52) U.S. Cl. 348/218.1

(57) ABSTRACT

A video camera apparatus for whole space monitoring is provided, which includes a lens module having a plurality of lenses, a calculation unit, and a processing unit. The lens module captures images from different directions and generates a plurality of image data, then outputs the image data to the calculation unit. The calculation unit calculates the received image data and outputs the image data to the processing unit. The processing unit compresses the image data according to the output of the calculation unit and outputs the compressed image data to the host apparatus.

### BACKGROUND OF THE INVENTION

1. Field of Invention

The present invention relates to a video camera apparatus. More particularly, the present invention relates to a video camera apparatus for whole space monitoring.

2. Description of Related Art

In a monitoring system, the width of the monitored range and the instantaneity of the monitored images are two important factors for judging the performance of the monitoring system. To have wider monitored range and more instant monitored images is what various monitoring systems want to achieve.

In conventional monitoring systems, a single lens is generally used by the monitoring video camera product for monitoring a fixed angle, which will cause visual dead angles.

Accordingly, some products, which can monitor the whole space with single lens through optical design, are provided. FIG. 1 is a schematic block diagram illustrating a conventional single lens video camera apparatus. Referring to FIG. 1, the conventional video camera apparatus including a big convex lens 104, a lens 106, a transparent fixing rod 108, and a small convex lens 110 is fixed to a fixing spot 102. Wherein, the lens 106 performs panoramic monitoring according to the optical reflection theory of the big convex lens 104 and the small convex lens 110.

However, the curvatures of the big convex lens 104 and the small convex lens 110 have to be calculated accurately when the video camera apparatus as shown in FIG. 1 processes the captured images, thus the procedure of image processing becomes very complicated. In addition, the viewing angle of this kind of lens is limited and cannot cover the entire monitored range, which may cause many monitoring dead angles and only half space (a half of an open visual space) images. In this case, a plurality of single lens monitoring video cameras have to be set up at different locations to achieve the purpose of multi-angle monitoring covering the whole monitored range, accordingly, the cost of cable layout and the maintenance expense are increased.

FIG. 2 is a diagram illustrating the image processing of the images captured by typical single lens video camera apparatuses which can only monitor one plane. Referring to FIG. 2, the images (202, 204, and 206 as shown in the figure) captured by 3 video cameras are combined into a panoramic image. The disadvantage of this method is that the 3 video cameras capture images from different locations, that it may be difficult to combine the panoramic image when the captured images contain different shooting angles. Moreover, since a plurality of video cameras is used, the complexity of cable layout is increased as well as the hardware cost.

In addition, even though some video camera products can perform whole space monitoring through a rotating single lens, they can not monitor the whole space simultaneously due to the time difference. Thus, even the purpose of whole space monitoring is achieved, the area outside of the image captured by the video camera at a particular time does not fall within the monitored range. As a result, a dead angle is occurred because of time difference.

The conventional method of setting up a plurality of video cameras at different locations, as described above, is not economical because it has many disadvantages such as difficulties in amending the angles of the panoramic image, wasting of installation space, increasing the system construction cost. Besides, extra cost in cable installation is needed when setting up the system, resulting in the increase in maintenance expense of the monitoring cable at later management. While if a single lens is used for single angle asynchronous whole space monitoring, dead angles in time will be occurred that the monitoring instantaneity cannot be achieved.

### SUMMARY OF THE INVENTION

Accordingly, the present invention is directed to provide a video camera apparatus for whole space (a 3-D open visual space) monitoring, which can capture images with no dead angles in space or in time, and can reduce the difficulty in angle amendment of panoramic image combination, lower the costs in product manufacturing, installation, maintenance and the installation space.

According to another aspect of the present invention, a video camera lens module is provided, wherein a plurality of lenses are mounted on the rotating portion thereof to capture images from different directions.

To achieve the aforementioned and other objectives, the present invention provides a whole space monitoring video camera apparatus for transferring the captured images to the host apparatus. The whole space monitoring video camera apparatus includes a lens module having a plurality of lenses, a calculation unit, and a processing unit. The lens module captures images from different locations and produces a plurality of image data, then outputs the image data to the calculation unit. The calculation unit calculates the received image data and outputs the image data to the processing unit. The processing unit compresses the image data according to the output of the calculation unit and outputs the compressed image data to the host apparatus.

According to another aspect of the present invention, a whole space monitoring video camera apparatus is provided, which includes a lens module having a plurality of lenses, a first calculation unit, a processing unit, and a decoding device. Moreover, the decoding device further includes a second calculation unit and a decompressing unit. The lens module captures images from different locations and produces a plurality of image data, then outputs the image data to the calculation unit. The calculation unit calculates the received image data and outputs the image data to the processing unit. The processing unit compresses the image data according to the output of the calculation unit and outputs the compressed image data to the decoding device through a transmission interface.

The decoding device includes a second calculation unit and a decompressing unit. When the output of the calculation unit is sent to the decoding device, the second calculation unit. Next, the second calculation unit sorts out the image frames produced by different methods and outputs the result to the decompressing unit to be decompressed, so as to form a panoramic image eventually.

According to yet another aspect of the present invention, a lens module is provided, which includes a fixing portion and a rotating portion. Wherein, a plurality of lenses can be mounted on the rotating portion, and the rotating portion can be attached to a bonding surface of the fixing portion rotationally.

According to the present invention, a lens module structure having a plurality of lenses is adopted and the lenses can capture images from different locations simultaneously to capture images of multiple angles, so as to monitor 360° half space or 3D whole space, therefore the captured images have no dead angle in space or in time. Moreover, since the plurality of lenses have been integrated into a lens module structure, the angle amendment in combining the panoramic image becomes easy. Furthermore, the extra cost in cable layout when installing the system and the expense in future maintenance can be avoided. Accordingly, the cost in product manufacturing and maintenance is reduced. In addition, the same system can be used in different monitored environments and to meet different monitoring requirements by integration with different image compressing and combination technologies, so as to further reduce the cost of redesigning the system.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram illustrating a conventional single lens video camera apparatus.

FIG. 2 is a diagram illustrating the image processing of the images captured by typical single lens video camera apparatuses which can only monitor one plane.

FIG. 3 is a circuit block diagram of a whole space monitoring video camera apparatus according to an exemplary embodiment of the present invention.

FIG. 4 is a circuit block diagram of a whole space monitoring video camera apparatus according to another embodiment of the present invention.

FIG. 5 is a circuit block diagram of a decoding device according to an exemplary embodiment of the present invention.

FIG. 6 is a diagram illustrating a double lenses module in a whole space monitoring video camera apparatus according to an embodiment of the present invention.

FIG. 7 is a diagram illustrating a triple lenses module in a whole space monitoring video camera apparatus according to an embodiment of the present invention.

FIG. 8 is a diagram illustrating a four lenses module in a whole space monitoring video camera apparatus according to an embodiment of the present invention.

FIG. 9 is a side view of a half space lens module in a whole space monitoring video camera apparatus according to an embodiment of the present invention.

FIG. 10 is a side view of a whole space lens module in a whole space monitoring video camera apparatus according to an embodiment of the present invention.

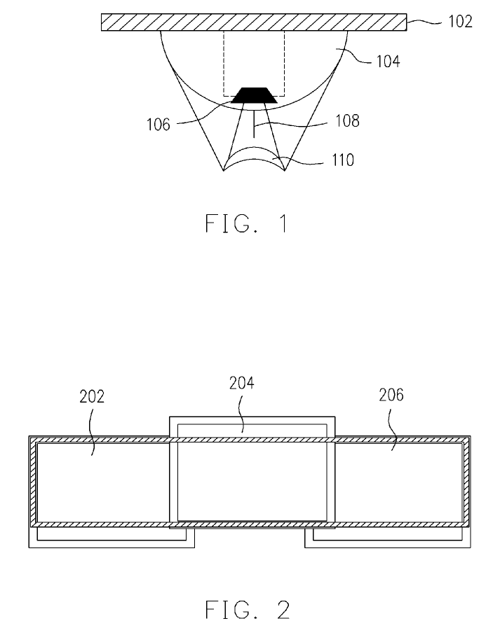

### DESCRIPTION OF EMBODIMENTS

To reduce difficulty in angle amendment of panoramic image combination, avoid extra cost in cable installation when setting up the system, and to reduce product manufacturing and maintenance cost, the present invention provides a whole space monitoring video camera apparatus different from the conventional technology. The content thereof will be described with reference to the embodiments as shown in the accompanying figures.

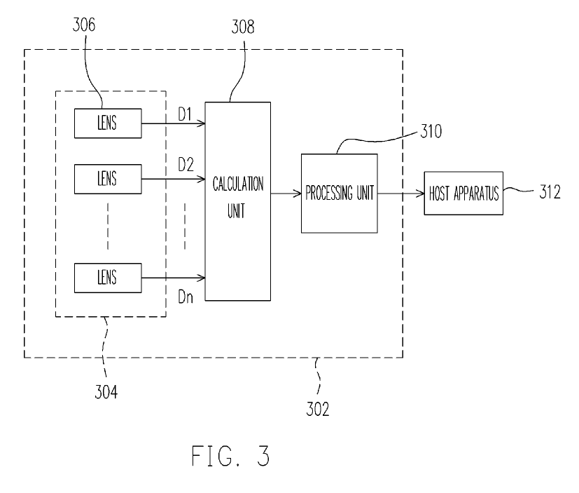

FIG. 3 is a circuit block diagram of a whole space monitoring video camera apparatus according to an exemplary embodiment of the present invention. Referring to FIG. 3, the video camera apparatus 302 includes a lens module 304, and the output of the lens module 304 is coupled to a calculation unit 308. In addition, the output of the calculation unit 308 is coupled to a processing unit 310, and the output of the processing unit 310 is coupled to a host apparatus 312.

Referring to FIG. 3 again, the lens module 304 includes a plurality of lenses 306 for capturing images from different angles, producing image data D1˜Dn respectively and outputting the image data D1˜Dn to the calculation unit 308. The calculation unit 308 calculates the received image data D1˜Dn, then the processing unit 310 compresses and combines the image data D1˜Dn according to the output of the calculation unit 308.

In the present embodiment, the processing unit 310 can combine and compress all the image data D1˜Dn according to the user's settings. In addition, the processing unit 310 can also combine and compress part of the image data D1˜Dn, or compress each of the image data D1˜Dn respectively, to produce image frames. Next, the processing unit 310 outputs the processed result to the host apparatus 312, so that the user can view the images captured by the lenses 306 through the host apparatus.

It should be understood by those skilled in the art that the present invention is not only for transferring the captured images to the host apparatus 312. In actual application, the user can also control the video camera apparatus 302 through the host apparatus 312. The host apparatus 312 may be placed close to the video camera apparatus 302 by cable connection, or may be placed anywhere by wireless communication network, so that the user can change the shooting angle of the video camera through the host apparatus, or even require the video camera to enlarge a particular part of the image when an abnormity is found in this particular part of the captured image.

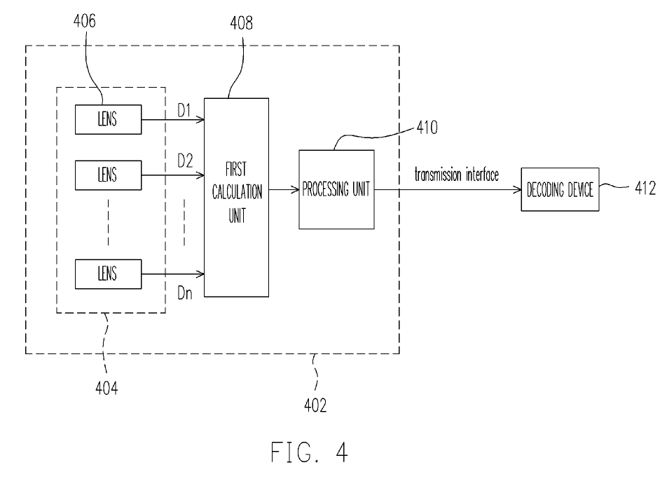

FIG. 4 is a circuit block diagram of a whole space monitoring video camera apparatus according to another embodiment of the present invention. Referring to FIG. 4, the video camera apparatus provided by the present embodiment includes a camera module 402 and a decoding device 412. Wherein, similarly, the camera module 402 includes a lens module 404, a first calculation unit 408, and a processing unit 410.

Similarly, the lens module 404 includes a plurality of lenses 406 which are used for capturing images from different angles and producing image data D1˜Dn. The outputs of the lenses 406 are coupled to the first calculation unit 408 to transfer the produced image data D1˜Dn to the first calculation unit 408. Wherein, the working principles of the first calculation unit 408 and the processing unit 410 can be referred to the working principles of the calculation unit 308 and the processing unit 310 in FIG. 3 so the detail is not described again.

FIG. 5 is a circuit block diagram of a decoding device according to an exemplary embodiment of the present invention. Referring to both FIG. 4 and FIG. 5, the decoding device 412 includes a second calculation unit 504 and a decompressing unit 506. Wherein, the processing unit 410 transfers the output thereof to the second calculation unit 504 in the decoding device 412 through a transmission interface, then the second calculation unit 504 calculates the output of the processing unit 410. The aforementioned transmission interface may be the Internet, LAN, or any interface which supports data transmission and the transmission may be performed through wire or wireless communication network.

In the present embodiment, the second calculation unit 504 divides various image frames according to the output of the first calculation unit 408. The various image frames described above are produced by combining and compressing all the image data D1˜Dn, or produced by combining and compressing part of the image data D1˜Dn, or produced by compressing individual image data D1˜Dn. As described above, the second calculation unit 504 sorts out the image frames produced by different methods and outputs the result to the decompressing unit 506 to be decompressed, so as to form the panoramic image eventually.

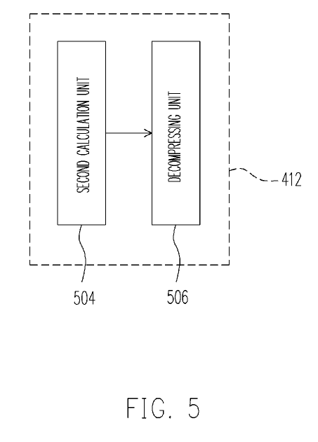

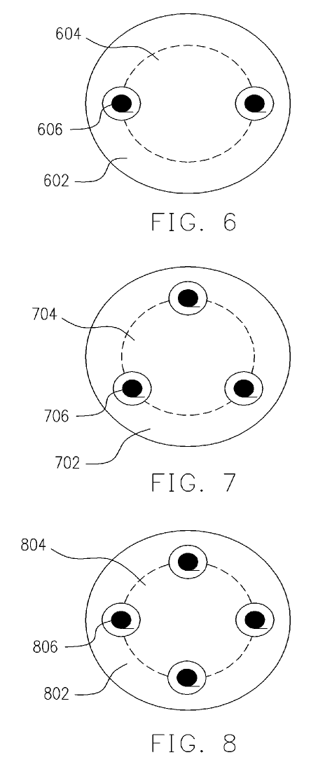

The lens modules (304, 404) in the embodiments described above can be implemented as a dual-lenses module of a whole space monitoring video camera apparatus illustrated in FIG. 6 according to an embodiment of the present invention. The dual lenses module includes a first fixing portion 602, a first rotating portion 604, and two first lenses 606. The dashed line in FIG. 6 represents the rotation path, which means the first rotating portion 604 is attached to the first fixing portion 602 rotationally. Thus, the two first lenses 606 can be used to capture multi-angle images.

The embodiment as shown in FIG. 6 can be modified by those skilled in the art according to the requirement, for example, adding additional lenses to the rotating portion. Referring to FIG. 7, FIG. 7 is a diagram illustrating a triple lenses module in a whole space monitoring video camera apparatus according to an embodiment of the present invention, and FIG. 8 is a diagram illustrating a four lenses module in a whole space monitoring video camera apparatus according to an embodiment of the present invention. Wherein, 702 and 802 correspond to 602 in FIGS. 6, 704 and 804 correspond to 604 in FIG. 6, and 706 and 806 correspond to 606 in FIG. 6. After referring to the embodiments in FIG. 7 and FIG. 8, it can be deduced easily by those using the technology in the present invention that N (N>0) lenses can be installed to the lens module, thus the embodiments illustrated in FIGS. 6, 7, and 8 are only a portion of the embodiments of the present invention.

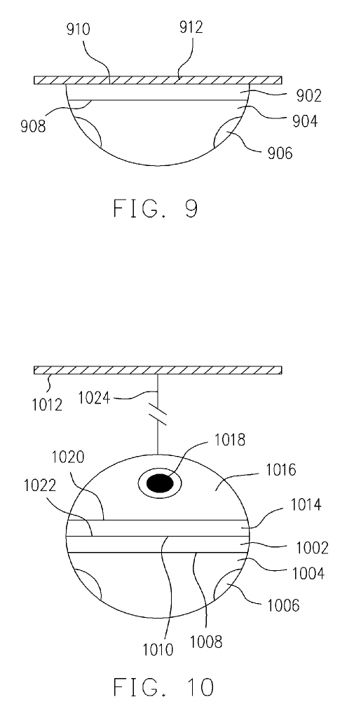

When the lens module has more than 3 lenses, the scene of a half space can be covered. Referring to the side view of the half space lens module in a whole space monitoring video camera apparatus illustrated in FIG. 9 according to an embodiment of the present invention, the half space lens module includes a first fixing portion 902 having a first bonding surface 908 and a second bonding surface 910, a first rotating portion 904, a plurality of first lenses 906, and a fixing spot 912. Wherein, all the first lenses 906 are mounted on the first rotating portion 904. The first rotating portion 904 is fixed on the first bonding surface 908 of the first fixing portion 902. The entire half space lens module is fixed on the fixing spot 912 by the second bonding surface 910 of the first fixing portion 902. Wherein, the fixing spot 912 is any surface whereto the half space lens module can be fixed.

Two half space lens modules can be integrated into a whole space lens module by those skilled with the technology illustrated in FIG. 9 according to the requirement. Referring to the side view of the whole space lens module in a whole space monitoring video camera apparatus illustrated in FIG. 10 according to an embodiment of the present invention, the whole space lens module includes a first fixing portion 1002 having a first bonding surface 1008 and a second bonding surface 1010, a first rotating portion 1004, a plurality of first lenses 1006, a second fixing portion 1014 having a third bonding surface 1020 and a fourth bonding surface 1022, a second rotating portion 1016, a plurality of second lenses 1018, a fixing spot 1012, and a hanging line 1024. 1014, 1016, 1018, 1020, and 1022 correspond to 1002, 1004, 1006, 1008, and 1010 respectively.

Wherein, all the first lenses 1006 are mounted on the first rotating portion 1004. The first rotating portion 1004 is attached on the first bonding surface 1008 of the first fixing portion 1002 while all the second lenses 1018 are mounted on the second rotating portion 1016. The second rotating portion 1016 is attached on the third bonding surface 1020 of the second fixing portion 1014. The second bonding surface 1010 of the first fixing portion 1002 is linked to the fourth bonding surface 1022 of the second fixing portion 1014, thus, two half space lens modules can be integrated into a spherical whole space lens module. Then, the hanging line 1024 is installed on the second rotating portion 1016 according to the actual length required and is fixed to the fixing spot 1012, so that the first lens module can capture images from the lower half of a space and the second lens module can capture images from the upper half of the space. Wherein, the hanging line 1024 can be a rope or pipe of any material that can sustain the weight of the whole space lens module. The fixing spot 1012 is any surface whereon the hanging line 1024 can be fixed. Moreover, the user can set a first predetermined angle and a second predetermined angle according to the actual requirement, and configure the first lenses and the second lenses according to the first predetermined angle and the second predetermined angle. Besides, the user can also set the first predetermined angle to be identical with the second predetermined angle, thus the number of the first lenses is the same as the number of the second lenses. Accordingly, processing the image data becomes easier.

The half space and whole space lens modules as described above can be integrated and applied to any space according to particular requirement the user wants to monitor. For example, a double lenses module can be used in an L-shape hallway or a straight hallway, scene of two directions can be monitored since the viewing angles of the two lenses can be adjusted randomly. And, for example, a triple lenses module can be hung in a close space such as a hall or a room, and the viewing angles of the three lenses can be adjusted to 120° respectively, so that the total of the three viewing angles is equal to 360°, thus monitoring the panoramic image can be achieved and no dead angles at any direction will be occurred. Furthermore, for example, two triple lenses modules can be combined into a spherical whole space lens module, which can be hung in a large open space such as the lobby of a hotel, a banquet hall, or a shopping mall, so that a whole space image combined by two half space images captured can be monitored.

In overview, according to the whole space monitoring video camera apparatus provided by the present invention, not only the angle amendment of the panoramic image combination is made easier, but the installation space and the product manufacturing cost are also reduced. Especially, there will be no dead angles in space or in time caused in the conventional structure. Moreover, the additional layout cost required when setting up the system and the expense of future maintenance can be saved, so that the economic efficiency of the video camera apparatus is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A video camera apparatus for whole space monitoring, used for transferring the captured images to a host apparatus, the video camera apparatus comprising:
a lens module, having a plurality of lenses for capturing images from different directions and producing a plurality of image data;
a calculation unit, used for receiving the image data and calculating the received image data; and
a processing unit, used for compressing the image data according to the output of the calculation unit and outputting the result to the host apparatus.

2. The video camera apparatus as claimed in claim 1, wherein the processing unit compresses and combines all the image data.

3. The video camera apparatus as claimed in claim 1, wherein the processing unit compresses and combines part of the image data.

4. The video camera apparatus as claimed in claim 1, wherein the processing unit compresses the image data respectively.

5. A video camera apparatus for whole space monitoring, comprising:
a lens module, having a plurality of lenses for capturing images from different directions and producing a plurality of image data;
a first calculation unit, used for receiving the image data and calculating the received image data;
a processing unit, used for compressing the image data according to the output of the first calculation unit; and
a decoding device, used for receiving the output of the processing unit through a transmission interface, and for decompressing the output of the processing unit.

6. The video camera apparatus as claimed in claim 1, wherein the decoding device comprises:
a second calculation unit, used for dividing image frames of different formats according to the data format transferred from the processing unit; and
a decompressing unit, used for decompressing the output of the second calculation unit.

7. The video camera apparatus as claimed in claim 6, wherein the images of different formats include an image of all the image data combined and compressed, an image of part of the image data combined and compressed, and an image individually compressed.

8. The video camera apparatus as claimed in claim 5, wherein the transmission interface includes wire or wireless Internet.

9. The video camera apparatus as claimed in claim 5, wherein the transmission interface includes LAN.

10. The video camera apparatus as claimed in claim 5, wherein the processing unit compresses and combines all the image data.

11. The video camera apparatus as claimed in claim 5, wherein the processing unit compresses and combines part of the image data.

12. The video camera apparatus as claimed in claim 5, wherein the processing unit compresses the image data respectively.

13. A video camera lens module, comprising:
a first fixing portion, having a first bonding surface and a second bonding surface;
a first rotating portion, being attached to the first bonding surface rotationally; and
a plurality of first lenses, being mounted on the first rotating portion together to capture images from different locations.

14. The video camera lens module as claimed in claim 13 further comprising:
a second fixing portion, having a third bonding surface and a fourth bonding surface;
a second rotating portion, being attached to the third bonding surface rotationally;
a plurality of second lenses, being mounted on the second rotating portion together.

15. The video camera lens module as claimed in claim 14, wherein a first predetermined angle is equal to a second predetermined angle.

16. The video camera lens module as claimed in claim 14, wherein the second lenses are used for capturing images from the upper half of a space.

17. The video camera lens module as claimed in claim 13, wherein the first lenses are used for capturing images from the lower half of a space.

18. The video camera lens module as claimed in claim 13, wherein the number of the first lenses is equal to the number of the second lenses.
